(19) United States
(12) Patent Application Publication
(10) Pub. No.: US 2011/0065431 A1
(43) Pub. Date: Mar. 17, 2011

(54) METHOD AND APPARATUS FOR OBTAINING NEIGHBOURING CELL ATTRIBUTES

(76) Inventor: David Neil, Cambridgeshire (GB)

(21) Appl. No.: 12/919,624

(22) PCT Filed: Mar. 5, 2009
(86) PCT No.: PCT/EP09/52576

§ 371 Date: Nov. 30, 2010

(30) Foreign Application Priority Data
Mar. 12, 2008 (GB) 0804542.9

(51) Int. Cl. H04W 4/00

(52) U.S. Cl. 455/434

(57) ABSTRACT

A network element for providing access to a cellular communication network via a communication cell, the network element comprising signal processing logic arranged to initiate neighbour cell attribute discovery by a wireless communication unit located within the communication cell. The signal processing logic is further arranged to receive a neighbour cell attribute report from the wireless communication unit, extract neighbour cell attribute information from the received neighbour cell attribute report, and to update a neighbour cell list for the communication cell based on the extracted neighbour cell attribute information.

### FIELD OF THE INVENTION

The field of the invention relates to a method and apparatus for obtaining attributes of neighbouring cells within a cellular communication network, and in particular for obtaining neighbouring cell attributes for updating a neighbour cell list.

### BACKGROUND OF THE INVENTION

Wireless communication systems, such as the 3^{rd} Generation (3G) of mobile telephone standards and technology, are well known. An example of such 3G standards and technology is the Universal Mobile Telecommunications System (UMTS), developed by the 3^{rd} Generation Partnership Project (3GPP) (www.3gpp.org).

Typically, wireless communication units, or User Equipment (UE) as they are often referred to in 3G parlance, communicate with a Core Network (CN) of the 3G wireless communication system via a Radio Network Subsystem (RNS). A wireless communication system typically comprises a plurality of radio network subsystems, each radio network subsystem comprising one or more cells to which UEs may attach, and thereby connect to the network.

The 3^{rd} generation of wireless communications has been developed for macro-cell mobile phone communications. Such macro cells utilise high power base stations (Node-Bs in 3GPP parlance) to communicate with UEs within a relatively large coverage area.

Lower power (and therefore smaller coverage area) femto cells or pico-cells are a recent development within the field of wireless cellular communication systems. Femto cells or pico-cells (with the term femto cells being used hereafter to encompass pico-cells or similar) are effectively communication coverage areas supported by low power base stations (otherwise referred to as Access Points (APs)). These femto cells are intended to be able to be piggy-backed onto the more widely used macro-cellular network and support communications to UEs in a restricted, for example ‘in-building’, environment.

In this regard, a femto cell that is intended to support communications according to the 3GPP standard will hereinafter be referred to as a 3G femto cell. Similarly, an access controller intended to support communications with a low power base station in a femto cell according to the 3GPP standard will hereinafter be referred to as a 3^{rd} generation access controller (3G AC). Similarly, an Access Point intended to support communications in a femto cell according to the 3GPP standard will hereinafter be referred to as a 3^{rd} Generation Access Point (3G AP).

Typical applications for such 3G femto cell APs include, by way of example, residential and commercial (e.g. office) locations, ‘hotspots’, etc, whereby an AP can be connected to a core network via, for example, the Internet using a broadband connection or the like. In this manner, femto cells can be provided in a simple, scalable deployment in specific in-building locations where, for example, network congestion at the macro-cell level may be problematic.

Typically, each 3G femto cell AP is owned by a member of the public, as opposed to a Network Operator, and the owner of the 3G AP pays for the network resources, such as Digital Subscriber Line (DSL) bandwidth, used through the femto cell. As a result, it is undesirable for unauthorised UEs to use the femto cell as it will result in the owner paying for the network resources utilised. Accordingly, it is desirable for access control to be provided on a cellular level, enabling an owner of, for example, a femto cell AP to be able to control which UEs are able to access the network via the femto cell.

In a traditional macro-cellular network, since base stations (Node Bs) are generally owned and operated by the network operator, the macro-cellular networks are typically planned, for exampled in terms of the locations of macro-cells. However, femto-cell access points are typically privately owned, that is not owned by the network operator, and therefore the location of individual femto-cells is not planned within the context of the overall network.

As will be appreciated by a skilled artisan, within cellular communication networks, such as a UMTS network, each cell comprises a neighbour cell list. In a planned macro cell network, a so-called neighbour cell list is used to identify adjacent cells to each macro cell, to facilitate handover of UE communications between cells. The neighbour cell list is broadcast to roaming UEs via Node-Bs to enable the roaming UE to receive and assess the suitability of continuing a communication by transferring the communication to an adjacent (neighbour) cell. For a 3GPP network, the neighbour cell list of the macro cell contains frequency and scrambling code information for all of the cells whose coverage area overlaps with the macro cell, to allow the UE to be able to receive and decode transmissions from the neighbouring cells.

Accordingly, when a new femto-cell is deployed, or when a femto-cell is moved, it needs to be configured with a list of neighbour cells. A problem with femto-cell networks is that, since the locations of femto-cells are typically not pre-planned, the neighbour cell list for each femto-cell is not predictable, and must be individually configured. A femto-cell network may comprise millions of femto-cells. Consequently, it is not feasible to manually configure the neighbour cell list for each femto-cell. This problem is further compounded by the fact that, as previously mentioned, femto-cell access points are typically privately owned, and thus the owners thereof do not necessarily have access to details of neighbouring cells.

As a skilled artisan will know, in a 3^{rd} Generation network, such as a UMTS network, uplink transmissions (from the user equipment (UE) to the network) and downlink transmissions (from the network to the UE) operate at different frequencies. Accordingly, a typical femto-cell access point comprises a transmitter for the downlink frequency and a receiver for the uplink frequency. One proposed solution to the abovementioned problem is for the femto-cell access point to comprise a further ‘UE’ receiver to operate on a downlink frequency, or to modify the existing receiver to be configurable between the uplink and downlink frequencies. In this manner, the access point would be able to scan and monitor the surrounding network and locate neighbour cells itself. Thus, the access point would be able to self-configure the neighbour cell list for the femto-cell based on observed neighbour cells within the surrounding network.

However, a problem with this proposed solution is that it significantly adds to the cost and number of components for the access point, and also adds to the cost and complexity of software development and/or licensing for operating the access point.

Furthermore, typically the access point will be located at a fixed physical position. Accordingly, measurements will be limited to being taken from that same position. As will be appreciated by a skilled artisan, it is possible for a neighbour cell to be ‘visible’ to a receiver from one location within a cell, whilst being ‘invisible’ to a receiver from a different location within the same cell. Accordingly, since the physical position of the access point is generally fixed, neighbouring cells that are invisible from that fixed position will remain invisible to the access point, and therefore cannot be measured.

Thus, there exists a need for a method and apparatus for obtaining attributes of neighbouring cells within a cellular communication network.

### SUMMARY OF THE INVENTION

Accordingly, the invention seeks to mitigate, alleviate or eliminate one or more of the abovementioned disadvantages singly or in any combination.

According to a first aspect of the invention, there is provided a network element for providing access to a cellular communication network via a communication cell. The network element comprises transceiver circuitry arranged to enable a connection to be established with at least one wireless communication unit located within the communication cell, and signal processing logic. The signal processing logic is arranged to initiate neighbour cell attribute discovery by a wireless communication unit located within the communication cell. The signal processing logic is further arranged to receive a neighbour cell attribute report from the wireless communication unit, extract neighbour cell attribute information from the received neighbour cell attribute report, and to update a neighbour cell list for the communication cell based at least on the extracted neighbour cell attribute information.

In this manner, the network element is able to update its neighbour cell list using neighbour cell attribute information received from the wireless communication unit. Accordingly, the network element is provided with the ability to substantially self-configure its neighbour list, thereby substantially alleviating the need for the neighbour list to be manually configured, which as previously mentioned may not be feasible. Furthermore, by utilising wireless communication units within the cell to perform the discovery of neighbour cell attributes, the need to modify the receiver of the network element, or to add additional ‘UE’ receiver circuitry is substantially avoided. Thus, the associated additional costs and increase in components is substantially avoided.

Moreover, by utilising a wireless communication unit to perform a discovery of neighbour cell attributes, the physical positions at which measurements may be taken to perform such recovery is not fixed. Accordingly, neighbouring cells that are ‘invisible’ to a wireless communication unit performing discovery of neighbour cell attributes at one location, may be visible to a wireless communication unit performing discovery of neighbour cell attributes at a different location, and thus their attributes can be discovered.

In accordance with an optional embodiment of the invention, the signal processing logic may be arranged to initiate neighbour cell attribute discovery by transmitting a neighbour cell attribute discovery setup message to the wireless communication unit.

In accordance with an optional embodiment, the neighbour cell attribute discovery setup message may comprise information relating to at least one frequency, for example at least one Absolute Radio Frequency Channel Number (ARFCN), at which to discover neighbour cell attributes.

In accordance with an optional embodiment, the neighbour cell attribute discovery setup message may comprise information relating to at least one scrambling code or Base Station Identity Code (BSIC) with which to discover neighbour cell attributes.

In this manner, the network element is able to control in which frequencies, or frequency channels, and with which scrambling codes or Base Station Identity Codes, neighbour cell attributes are discovered.

According to a second aspect of the invention, there is provided a method for obtaining attributes of neighbouring cells within a cellular communication network. The method comprises, at a network element, initiating neighbour cell attribute discovery by a wireless communication unit located within the communication cell; receiving a neighbour cell attribute report from the wireless communication unit; extracting neighbour cell attribute information from the received neighbour cell attribute report; and updating the neighbour cell list based at least on the extracted neighbour cell attribute information.

According to a third aspect of the invention, there is provided a wireless communication system adapted to support the abovementioned method for updating a neighbour cell list for a communication cell.

According to a fourth aspect of the invention there is provided a wireless communication unit comprising transceiver circuitry arranged to transmit and receive signals to and from a network element of a communication cell within a cellular communication network, and signal processing logic. The signal processing logic is arranged to receive a neighbour cell attribute discovery setup message from a network element. The signal processing logic is further arranged to perform discovery of at least one attribute for at least one neighbour cell in accordance with information provided within the neighbour cell attribute discovery setup message, and to transmit a neighbour cell attribute report to the network element, the neighbour cell attribute report comprising discovered neighbour cell attribute information.

According to a second aspect of the invention, there is provided a method for obtaining attributes of neighbouring cells within a cellular communication network. The method comprises, at a wireless communication unit, receiving a neighbour cell attribute discovery setup message from a network element; performing discovery of at least one attribute for at least one neighbour cell in accordance with information provided within the neighbour cell attribute discovery setup message; and transmitting a neighbour cell attribute report to the network element, wherein the neighbour cell attribute report comprises discovered neighbour cell attribute information.

According to a sixth aspect of the invention there is provided a computer-readable storage element having computer-readable code stored thereon for programming signal processing logic to perform a method for obtaining attributes of neighbouring cells within a cellular communication network, according to the aforementioned second and fifth aspects respectively.

These and other aspects, features and advantages of the invention will be apparent from, and elucidated with reference to, the embodiment(s) described hereinafter.

### BRIEF DESCRIPTION OF THE DRAWINGS

Embodiments of the invention will be described, by way of example only, with reference to the accompanying drawings, in which:

FIG. 1 illustrates an example of part of a cellular communications network in accordance with some embodiments of the invention;

FIG. 2 illustrates a simplified flowchart of a method for obtaining attributes of neighbouring cells within a cellular communication network according to some embodiments of the invention;

FIG. 3 illustrates a simplified flowchart of a method for performing neighbour cell attribute discovery by a wireless communication unit in accordance with some embodiments of the invention; and

FIG. 4 illustrates a typical computing system that may be employed to implement signal processing functionality in embodiments of the invention.

### DETAILED DESCRIPTION OF EMBODIMENTS OF THE INVENTION

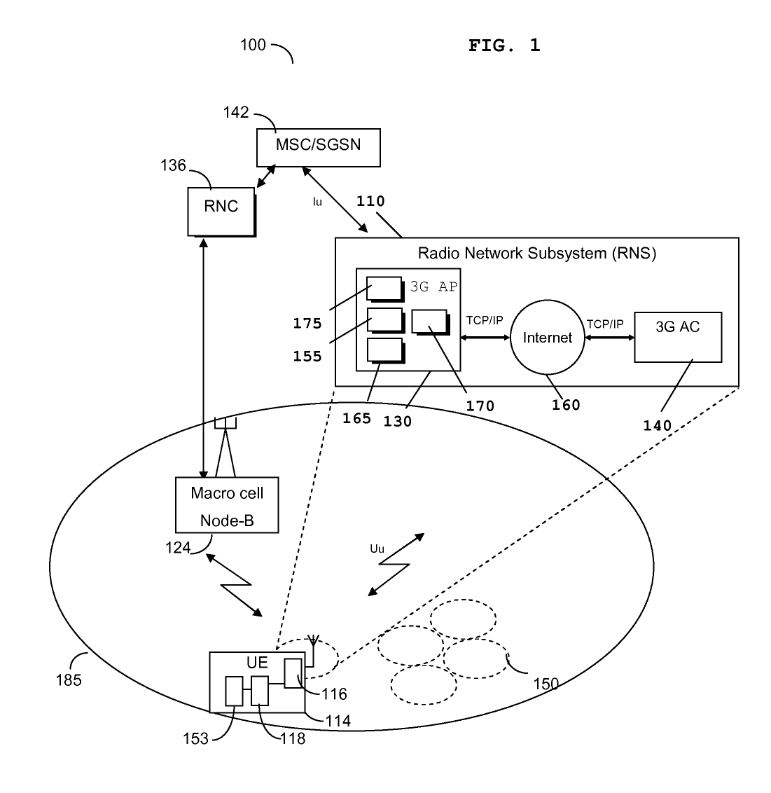

Referring now to the drawings, and in particular FIG. 1, an example of part of a Universal Mobile Telecommunications System (UMTS) network, adapted in accordance with some embodiments of the invention, is illustrated and indicated generally at 100. In FIG. 1, there is illustrated an example of a cellular communication system 100 combining macro cells 185 and femto-cells 150 in accordance with one embodiment of the invention. For the embodiment illustrated in FIG. 1, the cellular communication system 100 comprises two distinct radio network sub-system (RNS) architectures to handle the respective macro cell and femto-cell communications. In the macro cell scenario, the RNS comprises an RNC 136 operably coupled to a Node B 124 for providing a macro cell. The RNC 136 is further operably coupled to a core network element 142, such as a serving GPRS support node (SGSN)/mobile switching centre (MSC), as known.

In a femto-cell scenario, an RNS 110 comprises a network element in a form of a 3G Access Point (AP) 130, and a controller in a form of a 3G Access Controller (AC) 140. As will be appreciated by a skilled artisan, an access point is a network communication element that provides access to a cellular communication network via a communication cell, such as a femto-cell 150. One application is that a 3G AP 130 may be purchased by a member of the public and installed in their home. The 3G AP 130 may then be connected to a 3G AC 140 via a publicly or commercially available communication medium, such as via the Internet over the owner's broadband Internet connection 160.

Thus, a 3G AP 130 is a scalable, multi-channel, two-way communication device that may be provided within, say, residential and commercial (e.g. office) locations, ‘hotspots’ etc, to extend or improve upon network coverage within those locations. Although there are no standard criteria for the functional components of a 3G AP, an example of a typical 3G AP for use within a 3GPP system may comprise some aspects of Node-B functionality and some aspects of radio network controller (RNC) 136 functionality. The 3G AP 130 further comprises radio frequency (RF) transceiver circuitry 155 arranged to enable a connection to be established with one or more wireless communication units located within the communication cell 150, such as User Equipment (UE) 114, via a wireless interface (Uu).

The 3G AC 140 may be coupled to the core network (CN) 142 via an Iu interface as shown. In this manner, the 3G AP 130 is able to provide voice and data services to a cellular handset, such as UE 114, in a femto-cell in the same way as a conventional Node-B, but with the deployment simplicity of, for example, a Wireless Local Area Network (WLAN) access point. As would be appreciated by a skilled person, 3G AP 130 comprises numerous other functional and logical elements to support wireless communications and functionality and which will not be described further herein.

The UE 114 is a wireless communication unit comprising transceiver circuitry 116 arranged to transmit and receive signals, and signal processing logic 118. As would be appreciated by a skilled person, UE 114 comprises numerous other functional and logical elements to support wireless communications and functionality and which will not be described further herein.

As previously mentioned, a problem with femto-cell networks is that, since the locations of femto-cells are typically not pre-planned, a neighbour cell list for each femto-cell is not predictable, and must be individually configured. Furthermore, A femto-cell network may comprise millions of femto-cells. Consequently, it is not feasible to manually configure the neighbour cell list for each femto-cell. This problem is further compounded by the fact that, as previously mentioned, femto-cell access points are typically privately owned, and thus the owners thereof do not necessarily have access to details of neighbouring cells.

Thus, and in accordance with some embodiments of the invention, signal processing logic 165 of 3G AP 130 is arranged to initiate neighbour cell attribute discovery by a wireless communication unit operating within its cell 150, for example UE 114. The signal processing logic 165 is further arranged to receive a neighbour cell attribute report from the wireless communication unit, extract neighbour cell attribute information from the received neighbour cell attribute report, and to update a neighbour cell list for the cell 150 based at least on the extracted neighbour cell attribute information.

In this manner, the 3G AP 130 is able to update its neighbour cell list using neighbour cell attribute information received from the wireless communication unit. Accordingly, the 3G AP 130 is provided with the ability to automatically update its neighbour list, thereby substantially alleviating the need for the neighbour list to be manually configured, which as previously mentioned may not be feasible. Furthermore, by utilising wireless communication units within the cell to perform the discovery of neighbour cell attributes, the need to modify the receiver of the 3G AP 130, or to add additional ‘UE’ receiver circuitry may be substantially avoided, and thus the associated additional costs and increase in components may be substantially avoided.

Moreover, by utilising wireless communication unit to perform the discovery of neighbour cell attributes, the physical positions at which measurements may be taken to perform such recovery is not fixed. Accordingly, neighbouring cells that are ‘invisible’ to a wireless communication unit performing discovery of neighbour cell attributes at one location, may be visible to a wireless communication unit performing discovery of neighbour cell attributes at a different location, and thus their attributes can be discovered.

The received neighbour cell attribute information may not only be used to update an existing neighbour cell list, but may also be used to create a neighbour cell list when one has not already been created, for example in a case where an access point or the like is deployed for the first time. Accordingly, the term ‘update’ used herein with reference to a neighbour cell list encompasses both the updating of an existing neighbour cell list and the creation of a new neighbour cell list.

Furthermore, although for the various embodiments described herein, embodiments of the invention are described in terms of an access point updating a neighbour cell list for a femto-cell, it is contemplated that the invention may equally be implemented within other forms of network element, such as a Node-B supporting communication in a macro-cell. In this manner, the Node-B is able to update the neighbour cell list for the macro-cell, for example to take into account femto-cells that may be deployed within the coverage area of its macro-cell.

In accordance with some embodiments of the invention, the signal processing logic 165 of 3G AP 130 is arranged to initiate the neighbour cell discovery by transmitting a neighbour cell attribute discovery setup message to the UE 114.

For example, a neighbour cell attribute discovery setup message may comprise an adapted Radio Resource Control (RRC) measurement control message. The RRC protocol is defined in the Universal Mobile Telecommunications System (UMTS) Radio Resource Control (RRC) Protocol specification (3GPP TS 25.331), and forms part of the network layer between the UE and the UMTS Terrestrial Radio Access Network (UTRAN). As known in the art, the RRC protocol comprises measurement control messages that enable the UTRAN to setup, modify and release measurements performed by wireless communication units. Accordingly, and in accordance with some embodiments of the invention, an existing RRC measurement control message may be adapted, or a new RRC message added to the RRC protocol, for the purpose of initiating, modifying and/or releasing neighbour cell attribute discovery information by wireless communication units.

As will be appreciated by a skilled artisan, cellular communication networks communicate with wireless communication units over a range of carrier frequencies. For example, for a GSM (Global System for Mobile Communications) network, carrier frequencies are designated by an Absolute Radio Frequency Channel Number (ARFCN). Similarly, for a UMTS network, carrier frequencies are specified by a UTRA (Universal Terrestrial Radio Access) Absolute Radio Frequency Channel Number (UARFCN). For simplicity, the term Absolute Radio Frequency Channel Number, and its acronym ARFCN, will hereinafter encompass UTRA Absolute Radio Frequency Channel Numbers (UARFCNs).

In accordance with some embodiments of the invention, the signal processing logic 165 may be arranged to transmit a neighbour cell attribute discovery setup message comprising information relating to one or more frequencies at which to discover neighbour cell attributes. For example, the signal processing logic 165 may be arranged to transmit a neighbour cell attribute discovery setup message comprising one or more ARFCNs. In this manner, the 3G AP 130 is able to specify on which frequency channels the wireless communication unit (UE 214) is to discover neighbour cell attributes.

Thus, the wireless communication unit is not required to scan through all frequency channels in order to identify neighbouring cells, which could take the wireless communication unit a long time. In particular, if it is known that an operator of a particular network, with which the 3G AP 130 forms a part, uses a specific subset of frequency channels, the 3G AP 130 may be configured to only scan through those frequency channels used by that network operator.

As will also be appreciated by a skilled artisan, within Code Division Multiple Access (CDMA) communication networks, more than one cell may communicate over the same frequency channel, with the communication signals for each cell being retrievable using scrambling codes. Thus, according to some embodiments of the invention, the signal processing logic 165 may be arranged to transmit a neighbour cell attribute discovery setup message comprising one or more scrambling codes with which to discover neighbour cell attributes. Furthermore, the neighbour cell attribute discovery setup message may comprise information relating to sets, or ranges, of scrambling codes.

In this manner, the 3G AP 130 is able to specify which scrambling codes the wireless communication unit is to use for discovering neighbour cell attributes.

Thus, the wireless communication unit is not required to scan through all scrambling codes in order to identify neighbouring cells, which could take the wireless communication unit a long time. In particular, if it is known that an Operator of a particular network with which the 3G AP 130 forms a part uses a specific subset of scrambling codes, the 3G AP 130 may be configured to only scan through those scrambling codes used by that network operator.

Alternatively, for Time Division Multiple Access (TDMA) communication system, such as a GSM communication system, a Base Station Identity Code (BSIC) is used to enable a wireless communication unit to distinguish between different neighbouring base stations using the same ARFCN. The BSIC comprises a Base station Colour Code (BCC) and a Network Colour Code (NCC).

Thus, according to some embodiments of the invention, the signal processing logic 165 may be arranged to transmit a neighbour cell attribute discovery setup message comprising one or more BSICs with which to discover neighbour cell attributes. Furthermore, the neighbour cell attribute discovery setup message may comprise information relating to sets, or ranges, of BSICs.

In accordance with further embodiments of the invention, the neighbour cell attribute discovery setup message may further comprise information defining criteria about those neighbouring cells to report attributes for. For example, the neighbour cell attribute discovery setup message may comprise one or more of the following:
(i) received signal power threshold, whereby only attributes for those cells for which the received signal power is greater than this threshold should be reported;
(ii) received signal quality threshold, whereby only attributes for those cells for which the received signal quality, for example based on a BLock Error Rate (BLER), is greater than this threshold, should be reported;
(iii) Mobile Country Code (MCC), whereby only attributes for those cells comprising a specified Mobile Country Code should be reported; and
(iv) Mobile Network Code (MNC), whereby only attributes for those cells comprising a specified Mobile Network Code, should be reported.

As is known in the art, the attributes for neighbour cells within a neighbour cell list may comprise, by way of example, one, a plurality, or all of the following attributes:
(i) cell identity;
(ii) radio network controller identity (RNCID);
(iii) mobile country code (MCC);
(iv) mobile network code (MNC);
(v) location area code (LAC); and/or
(vi) routing area code (RAC).

Accordingly, the neighbour cell attribute discovery setup message may comprise information identifying one or more of the above attributes to be discovered. In this manner, the 3G AP 130 is able to specify which attributes it requires the wireless communication unit to discover.

As previously mentioned, having initiated neighbour cell attribute discovery by a wireless communication unit, the signal processing logic 165 is arranged to receive a neighbour cell attribute report from the wireless communication unit, and to extract neighbour cell attribute information from the received report. In accordance with some embodiments of the invention, the neighbour cell attribute report may be in a form of an RRC measurement report message. For example, an existing RRC measurement report message may be adapted, or a new RRC message added to the RRC protocol, for the purpose of reporting neighbour cell attributes by wireless communication units.

Having extracted neighbour cell attribute information from the received neighbour cell attribute report message, for example from within one or more information elements (IEs) within the received neighbour cell attribute report message, the signal processing logic 165 updates (or creates) a neighbour cell list for the femto-cell 150 provided by the 3G AP 130. For example, in the case of updating an existing neighbour cell list, the signal processing logic 165 may retrieve the existing neighbour cell list from memory element 170, and update the neighbour cell list with the received information. The signal processing logic 165 may then store the updated neighbour cell list back in memory element 170. Alternatively, in a case of creating a new neighbour cell list, the signal processing logic may create the neighbour cell list, for example based on some template or other rules stored within memory element 170, and store the new neighbour cell list within memory element 170.

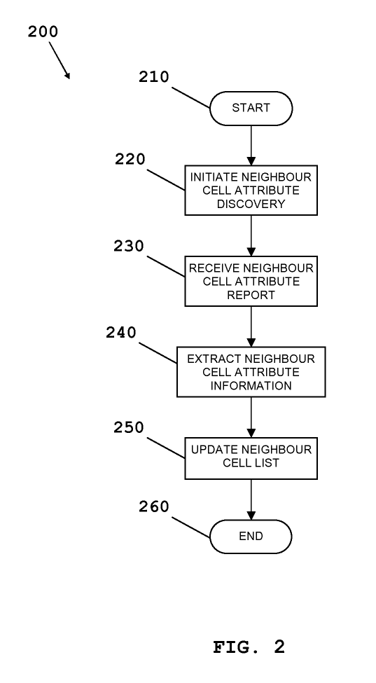

Referring now to FIG. 2, there is illustrated a simplified flowchart 200 of a method for obtaining attributes of neighbouring cells within a cellular communication network according to some embodiments of the invention. For example, the method of FIG. 2 may be implemented by signal processing logic within a network element, such as the 3G AP 130 or Node-B 124 of FIG. 1.

The method starts at step 210, for example when an access point, such as 3G AP 130 of FIG. 1 is first deployed, and the signal processing logic 165 determines that no valid neighbour cell list is present within memory element 170.

Alternatively, the method may be periodically implemented, for example in order to maintain a generally up-to-date neighbour cell list. Alternatively still, the method may be implemented pursuant to a command from a network management system, for example following a network re-plan comprising the frequencies and scrambling codes or BSICs used in, say, macro cells of the network being updated.

Next, in step 220, neighbour cell attribute discovery by a wireless communication unit located within the communication cell is initiated. For example, neighbour cell attribute discovery may be initiated by transmitting a neighbour cell attribute discovery setup message, such as an RRC protocol message, to the wireless communication unit.

The neighbour cell attribute discovery setup message may comprise information relating to one or more frequencies, for example one or more ARFCNs, at which to discover neighbour cell attributes. Furthermore, the neighbour cell attribute discovery setup message may comprise information relating to one or more scrambling codes or one or more BSICs (Base Station Identity Codes) with which to discover neighbour cell attributes.

As previously mentioned, the neighbour cell attribute discovery setup message may further comprise information defining criteria about those cells to report attributes for. For example, the neighbour cell attribute discovery setup message may comprise one or more of the following:
(i) received signal power threshold, whereby only attributes for those cells for which the received signal power is greater than this threshold should be reported;
(ii) received signal quality threshold, whereby only attributes for those cells for which the received signal quality, for example based on a BLock Error Rate (BLER), is greater than this threshold should be reported;
(iii) Mobile Country Code (MCC), whereby only attributes for those cells comprising a specified Mobile Country Code should be reported; and
(iv) Mobile Network Code (MNC), whereby only attributes for those cells comprising a specified Mobile Network Code should be reported.

The neighbour cell attribute discovery setup message may further comprise information identifying one or more attributes to be discovered. For example, the neighbour cell attribute discovery setup message may comprise a request for one or more of:
(i) cell identity;
(ii) radio network controller identity (RNCID);
(iii) mobile country code (MCC);
(iv) mobile network code (MNC);
(v) location area code (LAC); and/or
(vi) routing area code (RAC).

The method then moves on to step 230, with a receipt of a neighbour cell attribute report from the wireless communication unit. Neighbour cell attribute information is then extracted from the received neighbour cell report, in step 240, and the neighbour cell list is updated in step 250, based at least on the extracted neighbour cell attribute information. The method then ends, at step 260.

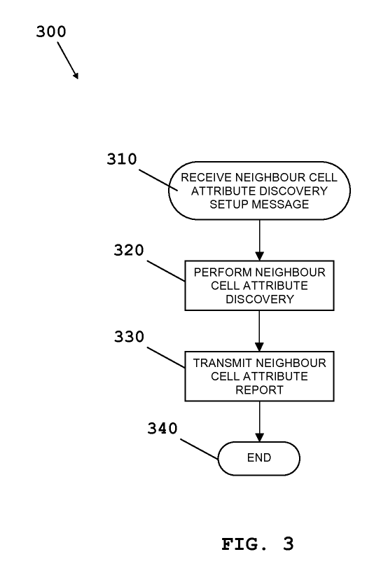

Referring now to FIG. 3, there is illustrated a simplified flowchart 300 of a method for performing neighbour cell attribute discovery, by a wireless communication unit, in accordance with some embodiments of the invention. For example, the method of FIG. 3 may be implemented by signal processing logic 118 of the UE 114 of FIG. 1.

The method starts at step 310 with a receipt of a neighbour cell attribute discovery setup message from a network element, for example an access point such as 3G AP 130 of FIG. 1, or a Node-B 124. Next, in step 320, discovery of one or more attributes for one or more neighbour cells is performed, in accordance with information provided within the neighbour cell attribute discovery setup message.

Having discovered the one or more attributes for the one or more neighbour cells, the method moves on to step 330, where a neighbour cell attribute report is transmitted to the network element, the neighbour cell attribute report comprising discovered neighbour cell attribute information. The method then ends at step 340.

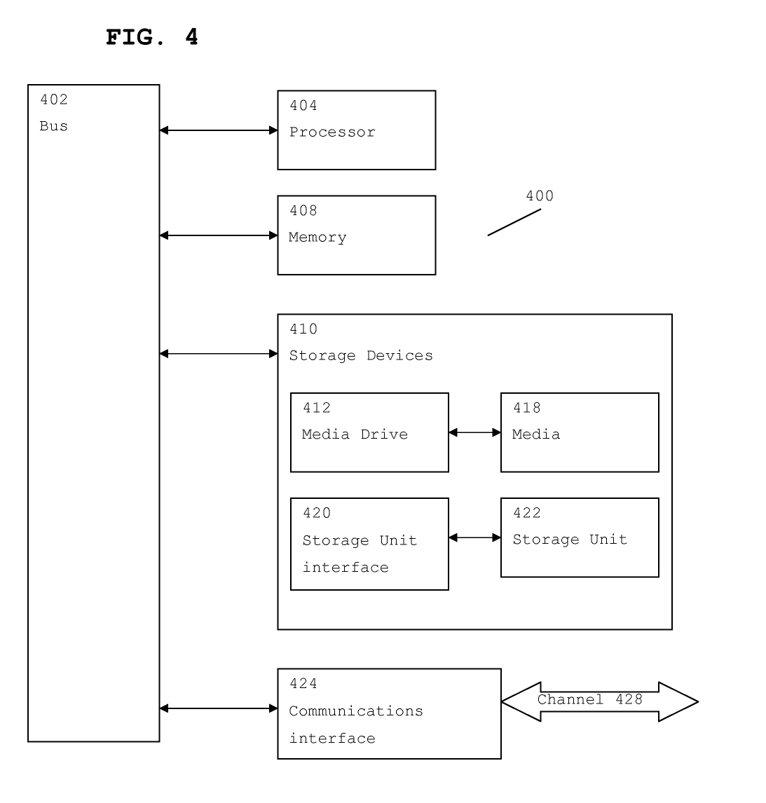

Referring now to FIG. 4, there is illustrated a typical computing system 400 that may be employed to implement signal processing functionality in embodiments of the invention.

Computing systems of this type may be used in network elements and wireless communication units. Those skilled in the relevant art will also recognize how to implement the invention using other computer systems or architectures. Computing system 400 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 400 can include one or more processors, such as a processor 404. Processor 404 can be implemented using a general or special-purpose processing engine such as, for example, a microprocessor, microcontroller or other control logic. In this example, processor 404 is connected to a bus 402 or other communications medium.

Computing system 400 can also include a main memory 408, such as random access memory (RAM) or other dynamic memory, for storing information and instructions to be executed by processor 404. Main memory 408 also may be used for storing temporary variables or other intermediate information during execution of instructions to be executed by processor 404. Computing system 400 may likewise include a read only memory (ROM) or other static storage device coupled to bus 402 for storing static information and instructions for processor 404.

The computing system 400 may also include information storage system 410, which may include, for example, a media drive 412 and a removable storage interface 420. The media drive 412 may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media 418 may include, for example, a hard disk, floppy disk, magnetic tape, optical disk, CD or DVD, or other fixed or removable medium that is read by and written to by media drive 412. As these examples illustrate, the storage media 418 may include a computer-readable storage medium having particular computer software or data stored therein.

In alternative embodiments, information storage system 410 may include other similar components for allowing computer programs or other instructions or data to be loaded into computing system 400. Such components may include, for example, a removable storage unit 422 and an interface 420, such as a program cartridge and cartridge interface, a removable memory (for example, a flash memory or other removable memory module) and memory slot, and other removable storage units 422 and interfaces 420 that allow software and data to be transferred from the removable storage unit 418 to computing system 400.

Computing system 400 can also include a communications interface 424. Communications interface 424 can be used to allow software and data to be transferred between computing system 400 and external devices. Examples of communications interface 424 can include a modem, a network interface (such as an Ethernet or other NIC card), a communications port (such as for example, a universal serial bus (USB) port), a PCMCIA slot and card, etc. Software and data transferred via communications interface 424 are in the form of signals which can be electronic, electromagnetic, and optical or other signals capable of being received by communications interface 424. These signals are provided to communications interface 424 via a channel 428. This channel 428 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms ‘computer program product’ ‘computer-readable medium’ and the like may be used generally to refer to media such as, for example, memory 408, storage device 418, or storage unit 422. These and other forms of computer-readable media may store one or more instructions for use by processor 404, to cause the processor to perform specified operations. Such instructions, generally referred to as ‘computer program code’ (which may be grouped in the form of computer programs or other groupings), when executed, enable the computing system 400 to perform functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 400 using, for example, removable storage drive 422, drive 412 or communications interface 424. The control logic (in this example, software instructions or computer program code), when executed by the processor 404, causes the processor 404 to perform the functions of the invention as described herein.

It will be appreciated that, for clarity purposes, the above description has described embodiments of the invention with reference to different functional elements and processors. However, it will be apparent that any suitable distribution of functionality between different functional elements or processors, for example with respect to the access point or controller, may be used without detracting from the invention. For example, it is envisaged that functionality illustrated to be performed by separate processors or controllers may be performed by the same processor or controller. Hence, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors. Thus, the elements and components of an embodiment of the invention may be physically, functionally and logically implemented in any suitable way. Indeed, the functionality may be implemented in a single unit, in a plurality of units or as part of other functional units.

Although one embodiment of the invention describes a 3G AP for a UMTS/3GPP network, it is envisaged that the inventive concept is not restricted to this embodiment.

It is envisaged that the aforementioned inventive concept aims to provide at least an advantage of providing network elements with a capability for substantially self configuration of neighbour cell lists, without the need to modify the receiver of the network element, or to add additional ‘UE’ receiver circuitry, and thus avoiding the associated additional costs and increase in components.

Although the invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Moreover, an embodiment can be implemented as a computer-readable storage element having computer readable code stored thereon for programming a computer (e.g., comprising a signal processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’ etc. do not preclude a plurality.

Thus, a method and apparatus for obtaining attributes of neighbouring cells within a cellular communication network have been described, which substantially addresses at least some of the shortcomings of past and present access control techniques and/or mechanisms.

1. A network element (124, 130) for providing access to a cellular communication network (100) via a communication cell (150, 185), the network element comprising:
transceiver circuitry (155) arranged to enable a connection to be established with at least one wireless communication unit (114) located within the communication cell (150, 185); and
signal processing logic (165),
wherein the signal processing logic (165) is arranged to:
initiate neighbour cell attribute discovery by a wireless communication unit (114) located within the communication cell (150, 185);
receive a neighbour cell attribute report from the wireless communication unit (114);
extract neighbour cell attribute information from the received neighbour cell attribute report; and
update a neighbour cell list for the communication cell (150, 185) based at least partly on the extracted neighbour cell attribute information.

2. The network element (124, 130) of claim 1 wherein the signal processing logic (165) is arranged to initiate neighbour cell attribute discovery by transmitting a neighbour cell attribute discovery setup message to the wireless communication unit (114).

3. The network element (124, 130) of claim 2 wherein the neighbour cell attribute discovery setup message comprises information relating to at least one frequency at which to discover neighbour cell attributes.

4. The network element (124, 130) of claim 3 wherein the neighbour cell attribute discovery setup message comprises information relating to at least one of:
(i) at least one Absolute Radio Frequency Channel Number (ARFCN),
(ii) at least one Universal Terrestrial Radio Access (UTRA) Absolute Radio Frequency Channel Number (UARFCN).

5. The network element (124, 130) of any of claims 2 to 4 wherein the neighbour cell attribute discovery setup message comprises information relating to at least one scrambling code or Base Station Identity Code (BSIC) with which to discover neighbour cell attributes.

6. The network element (124, 130) of claim 5 wherein the information relating to at least one scrambling code or BSIC associates the at least one scrambling code or BSIC with at least one frequency.

7. The network element (124, 130) of any of claims 2 to 6 wherein the neighbour cell attribute discovery setup message comprises information defining criteria on those cells to report attributes for.

8. The network element (124, 130) of claim 7 wherein the neighbour cell attribute discovery setup message comprises information defining at least one of:
received signal power threshold;
received signal quality threshold;
mobile country code (MCC); and
mobile network code (MNC).

9. The network element (124, 130) of any of claims 2 to 8 wherein the neighbour cell attribute discovery setup message comprises information identifying at least one attribute to be discovered, the at least one attribute comprising at least one of:
cell identity;
radio network controller identity (RNCID);
mobile country code (MCC);
mobile network code (MNC);
location area code (LAC); and
routing area code (RAC).

10. The network element (124, 130) of any of claims 2 to 9 wherein the neighbour cell attribute discovery setup message comprises a Radio Resource Control (RRC) measurement control message, and the neighbour cell attribute report comprises a RRC measurement report message.

11. The network element (130) of any preceding claim wherein the network element comprises an access point, and the communication cell (150) comprises a femto-cell.

12. The network element (124) of any of claims 1 to 10 wherein the network element comprises a Node-B, and the communication cell (185) comprises a macro-cell.

13. A method (200) for obtaining attributes of neighbouring cells within a cellular communication network, the method comprising, at a network element:
initiating neighbour cell attribute discovery by a wireless communication unit located within the communication cell (220);
receiving a neighbour cell attribute report from the wireless communication unit (230);
extracting neighbour cell attribute information from the received neighbour cell attribute report (240); and
updating the neighbour cell list based at least on the extracted neighbour cell attribute information (250).

14. A wireless communication system (100) adapted to support the method for updating a neighbour cell list for a communication cell of claim 13.

15. A wireless communication unit (114) comprising transceiver circuitry (116) arranged to transmit and receive signals to and from a network element (124, 130) of a communication cell (150, 185) within a cellular communication network (100), and signal processing logic (118), wherein the signal processing logic (118) is arranged to:
receive a neighbour cell attribute discovery setup message from the network element (124, 130);
perform discovery of at least one attribute for at least one neighbour cell in accordance with information provided within the neighbour cell attribute discovery setup message; and
transmit a neighbour cell attribute report to the network element (124, 130), wherein the neighbour cell attribute report comprises discovered neighbour cell attribute information.

16. A method (200) for obtaining attributes of neighbouring cells within a cellular communication network, the method comprising, at a wireless communication unit,
receiving a neighbour cell attribute discovery setup message from a network element (124, 130);
performing discovery of at least one attribute for at least one neighbour cell in accordance with information provided within the neighbour cell attribute discovery setup message; and
transmitting a neighbour cell attribute report to the network element (124, 130), wherein the neighbour cell attribute report comprises discovered neighbour cell attribute information.

17. A computer-readable storage element (408) having computer-readable code stored thereon for programming signal processing logic (404) to perform a method (200) for obtaining attributes of neighbouring cells within a cellular communication network, the computer-readable storage element (270) comprising code for:
initiating neighbour cell attribute discovery by a wireless communication unit located within the communication cell (220);
receiving a neighbour cell attribute report from the wireless communication unit (230);
extracting neighbour cell attribute information from the received neighbour cell attribute report; and
updating the neighbour cell list based on the extracted neighbour cell attribute information.

18. A computer-readable storage element (408) having computer-readable code stored thereon for programming signal processing logic (404) to perform a method (300) for obtaining attributes of neighbouring cells within a cellular communication network, the computer-readable storage element comprising code for:
receiving a neighbour cell attribute discovery setup message from a network element (124, 130);
performing discovery of at least one attribute for at least one neighbour cell in accordance with information provided within the neighbour cell attribute discovery setup message; and
transmitting a neighbour cell attribute report to the network element (124, 130), wherein the neighbour cell attribute report comprises discovered neighbour cell attribute information

19. The computer-readable storage element (408) of claim 17 or claim 18, wherein the computer readable storage medium comprises at least one of a hard disk, a CD-ROM, an optical storage device, a magnetic storage device, a ROM (Read Only Memory), a PROM (Programmable Read Only Memory), a EPROM (Erasable Programmable Read Only Memory), a EEPROM (Electrically Erasable Programmable Read Only Memory) and a Flash memory.
